(19) United States
(12) Patent Application Publication
(10) Pub. No.: US 2013/0031160 A1
(43) Pub. Date: Jan. 31, 2013

(54) Web 3.0 Content Aggregation, Delivery and Navigation System

(71) Applicant: Christopher Carmichael, Laguna Niguel, CA (US)

(72) Inventor: Christopher Carmichael, Laguna Niguel, CA (US)

(21) Appl. No.: 13/535,081

(22) Filed: Jun. 27, 2012

Related U.S. Application Data
(60) Provisional application No. 61/501,686, filed on Jun. 27, 2011.

(51) Int. Cl. G06F 15/16

(52) U.S. Cl. 709/203

(57) ABSTRACT

A web 3.0 system combines social network information, advertising information, and multimedia information, all obtained from the same query.

This application claims priority from provisional application number 61501686, filed Jun. 27, 2011, the entire contents of which are herewith incorporated by reference.

### Inventors: Chris Carmichael

### BACKGROUND

The initial use of the internet, or world wide web, was in bulletin board style interactions. It could include graphics, but the graphics would be those that were requested. Eventually, the Web evolved to using markup language.

Web 2.0 came to be known as a web based platform, where the Web interacts with and allows interaction from, users, allowing collaboration between people according to their specific platforms.

There is no established definition for what will be called Web 3.0. Many believe that it will include semantic tagging of content.

### SUMMARY

The present application describes the current inventor's vision of Web 3.0, including aggregation of content, delivery, and navigation among different forms.

Web 2.0 allowing collaboration between different users. The current inventor believes that Web 3.0 will involve collaboration among different formats, such as video, audio, social, and textual content from different channels and sources.

### BRIEF DESCRIPTION OF THE DRAWINGS

FIG. 1 shows the aggregation of information used according to the Web 3.0 paradigm as described according to the present application.

### DETAILED DESCRIPTION

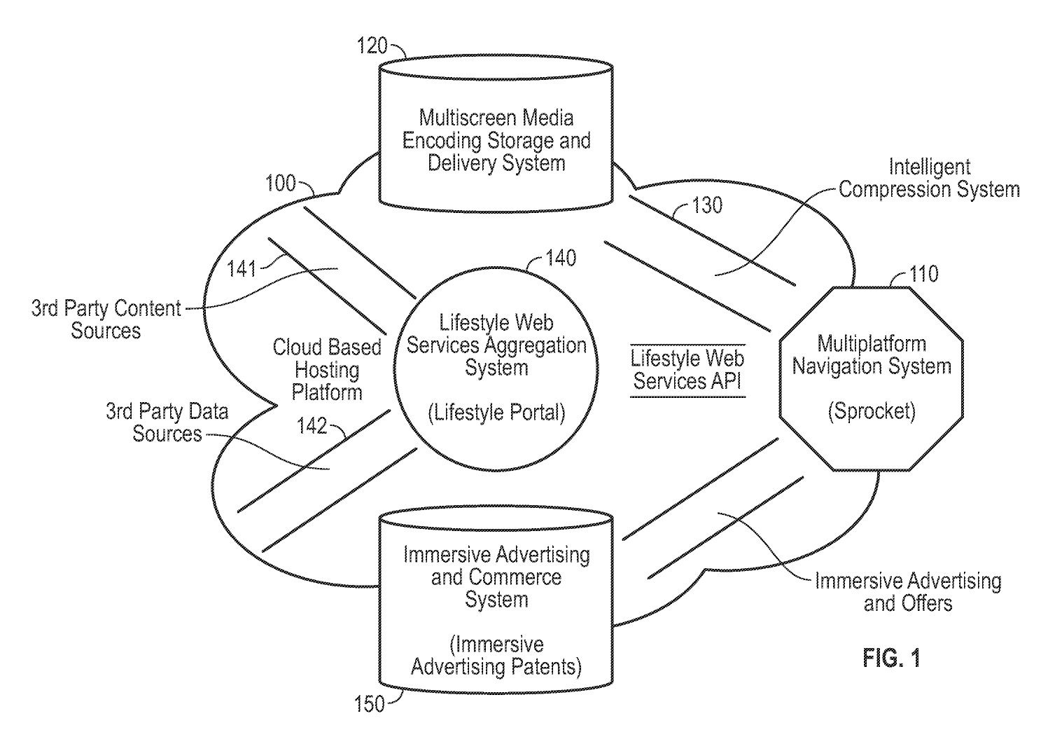

FIG. 1 shows an embodiment of The Web 3.0 content aggregation, delivery and navigation system is a new and unique way to combine, manage, display and distribute video, audio, social and textual content using a rich media transport mechanism and navigation interface that combines Internet and TV content with real-time motion graphics.

The Web 3.0 cloud 100 can be a series of servers that are interconnected to one another in order to provide an assortment of items of video, audio, social, textual and advertising, where all of those are from different servers or database, and all of those are returned for any specific request or operation that is carried out on the internet from a client. The requests or operation(s) can include requests for web pages, items on the web pages, chats or other communications, or anything else. Each sent ‘request’ gets sent to the multiple databases so that the multiple pieces of information are returned and provided to the user on the client.

According to an embodiment, a multiplatform navigation system 110 serves as the client. That multiplatform navigation system, for example, can be the “sprocket” client, described in U.S. patent application Ser. No. 13/205,422, the entire contents of which are herewith incorporated by reference. The sprocket in essence interacts with multiple different sources of information of different types and displays that information as a selectable hierarchy of information. However, any kind of client can be used.

The first kind of server shown as 120 represents multiscreen media which can be provided to multiple different kinds of clients, including a thin client, such as a cell phone, and desktop style clients. The multiscreen media may also for example have information that is optimized for tablets and other information. The information can be sent to be displayed on one client, or the single item of information spread among multiple clients in a way that the single set of information is displayed among multiple different screens of multiple different clients

For example, this may also use the techniques described in our U.S. Pat. No. 7,953,452, the entire contents of which are herewith incorporated by reference. All of the information from the multiscreen media is compressed by an intelligent compression system 130. One example of such a compression system is the type described in our U.S. patent application Ser. No. 13/305,304, the entire contents of which are herewith incorporated by reference.

The same query which is used for obtaining information from a video source 120 is also used to obtain information from a social media source such as 140. For example, 140 may be a lifestyle-specific information database server, such as the type described in our U.S. Pat. No. 7,590,556, the entire contents of which are herewith incorporated by reference. The lifestyle information provides social network information based on information that is either been collected by the server 140, or information that is collected or provided by the client 110. The lifestyle information also may include information from third-party sources 141 of content and data 142.

The web has evolved in a way to require the content to be free. Part of the information for the Web 3.0 content, moreover, is from advertising. Accordingly, the same query which is used to obtain media information and social information is also used to obtain advertising information from an immersive advertising server 150. For example, this may be of the type described in our U.S. Pat. No. 7,464,344, the entire contents of which are herewith incorporated by reference. This returned advertising information is immersive advertisement where the advertisement includes the user interaction as part of the advertisement.

As described above, these key components of the Web 3.0 system include a multiplatform navigation system, a multiscreen media encoding, storage and delivery systems, a lifestyle web services aggregation system, an immersive advertising and commerce system and an intelligent video compression system.

The software client 110 can run on many different platforms, including smart phones, tablets, web browsers and interactive tv systems, cloud based infrastructure for the storage, aggregation and monetization of 1^{st} and 3^{rd} party content as well as intelligent video and data compression and delivery systems.

Any request or information or any other interaction that is sent can simultaneously receive information based on the aggregation, combination and distribution of live and on-demand audio and video, social media, commerce, text and advertising in combination with a motion graphics based TV like interface that incorporates 2D and 3D interface elements.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example while the above describes only certain kinds of servers, it should be understood that all of this information can be obtained from a single server, or from multiple cloud-based and interconnecting versions of information.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the embodiments disclosed herein, may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. The processor can be part of a computer system that also has a user interface port that communicates with a user interface, and which receives commands entered by a user, has at least one memory (e.g., hard drive or other comparable storage, and random access memory) that stores electronic information including a program that operates under control of the processor and with communication via the user interface port, and a video output that produces its output via any kind of video output format, e.g., VGA, DVI, HDMI, displayport, or any other form.

When operated on a computer, the computer may be a server computer that sends information to multiple different client computers, or can be a client computer that interacts with a server computer, or can be a stand-alone computer operating based on stored instructions. The computer can include a processor that operates to accept user commands, execute instructions and produce output based on those instructions. The processor is preferably connected to a communication bus. The communication bus may include a data channel for facilitating information transfer between storage and other peripheral components of the computer system. The communication bus further may provide a set of signals used for communication with the processor, including a data bus, address bus, and/or control bus.

The communication bus may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCl”) local bus, or any old or new standard promulgated by the Institute of Electrical and Electronics Engineers (“IEEE”) including IEEE 488 general-purpose interface bus (“GPIB”), and the like.

A computer system used according to the present application preferably includes a main memory and may also include a secondary memory. The main memory provides storage of instructions and data for programs executing on the processor. The main memory is typically semiconductor-based memory such as dynamic random access memory (“DRAM”) and/or static random access memory (“SRAM”). The secondary memory may optionally include a hard disk drive and/or a solid state memory and/or removable storage drive for example an external hard drive, thumb drive, a digital versatile disc (“DVD”) drive, etc.

At least one possible storage medium is preferably a non-transitory computer readable medium, such as a hard drive, solid state drive, DVD or other memory of any form having stored thereon computer executable code (i.e., software) and/or data thereon in a non-transitory form. The computer software or data stored on the removable storage medium is read into the computer system as electrical communication signals.

The computer system may also include a communication interface. The communication interface allows' software and data to be transferred between computer system and external devices (e.g. printers), networks, or information sources. For example, computer software or executable code may be transferred to the computer to allow the computer to carry out the functions and operations described herein. The computer system can be a network-connected server with a communication interface. The communication interface may be a wired network card, or a Wireless, e.g., Wifi network card.

Software and data transferred via the communication interface are generally in the form of electrical communication signals.

Computer executable code (i.e., computer programs or software) are stored in the memory and/or received via communication interface and executed as received. The code can be compiled code or interpreted code or website code, or any other kind of code.

A “computer readable medium” can be any media used to provide computer executable code (e.g., software and computer programs and website pages), e.g., hard drive, USB drive or other. The software, when executed by the processor, preferably causes the processor to perform the inventive features and functions previously described herein.

A processor may also be implemented as a combination of computing devices, e.g., a combination of a DSP and a microprocessor, a plurality of microprocessors, one or more microprocessors in conjunction with a DSP core, or any other such configuration. These devices may also be used to select values for devices as described herein.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. The memory storage can also be rotating magnetic hard disk drives, optical disk drives, or flash memory based storage drives or other such solid state, magnetic, or optical storage devices. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. The computer readable media can be an article comprising a machine-readable non-transitory tangible medium embodying information indicative of instructions that when performed by one or more machines result in computer implemented operations comprising the actions described throughout this specification.

Operations as described herein can be carried out on or over a website. The website can be operated on a server computer, or operated locally, e.g., by being downloaded to the client computer, or operated via a server farm. The website can be accessed over a mobile phone or a PDA, or on any other client. The website can use HTML code in any form, e.g., MHTML, or XML, and via any form such as cascading style sheets (“CSS”) or other.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A system comprising:
a cloud based information returning system, that includes an interface that receives information sent by a user, and, based on said information, obtains all of video information, social information and advertising information, all from the same information sent by the user, and returns said video information, social information and advertising information to a querying client.

2. The system as in claim 1, wherein said video information is information that is optimized for displaying simultaneously on two different clients.

3. The system as in claim 2, wherein said information is optimized for displaying simultaneously on a desktop client and also on a mobile client, where said desktop client and said mobile clients display different parts of the information.

4. The system as in claim 1, wherein said advertising information is an immersive advertisement where the advertisement includes user interaction as part of the advertisement.

5. A system as in claim 1, wherein said social network information is provided by a website which analyzes lifestyle information of the user.
